(19) United States
(12) Patent Application Publication
(10) Pub. No.: US 2007/0118838 A1
(43) Pub. Date: May 24, 2007

(54) Task execution controller, task execution control method, and program

(76) Inventors: Masaaki Tsujino, Nara (JP); Kunihiko Hayashi, Osaka (JP)

Correspondence Address: MCDERMOTT WILL & EMERY LLP, 600 13TH STREET, N.W., WASHINGTON, DC, 20005-3096, US

(21) Appl. No.: 11/602,954

(22) Filed: Nov. 22, 2006

(30) Foreign Application Priority Data
Nov. 24, 2005 (JP) 2005-339329

(51) Int. Cl. G06F 9/46

(52) U.S. Cl. 718/103

(57) ABSTRACT

A task execution controller includes a task group judging unit and a priority control unit. The task group judging unit judges whether a first task and a second task belong to a same group, upon a request from the second task to access a resource that is shared among the plurality of task groups and is currently accessed by the first task. If the first and second tasks are judged to belong to the same group, the priority control unit (a) compares priorities of the first and second tasks and causes the first task to inherit the priority of the second task if the priority of the second task is higher. If the first and second tasks are judged to belong to different groups, the priority control unit raises a priority of the first task by a predetermined value.

### BACKGROUND OF THE INVENTION

(1) Field of the Invention

The present invention relates to a technique of task management executed by an OS (Operating System). More specifically, the present invention relates to a task execution controller, a task execution control method, and a program for carrying out execution control of a plurality of tasks having priorities assigned thereto.

(2) Description of the Related Art

The recent advancement of LSI (Large Scale Integrated Circuit) technology has lead to developments of various information processing devices. With such an information processing device, a CPU (Central Processing Unit) and other processors execute a predetermined program in an environment provided by an OS, so that various kinds of information processing can be carried out.

When a CPU and other processors execute a predetermined program on an OS, the OS manages the program in units called “tasks”. This function is called task management of the OS. The main job of the task management by OS is to control the execution order of a plurality of tasks.

According to prior art technology, if a program includes a plurality of tasks, each task is assigned a priority. When execution of two ore more tasks are concurrently requested, a task having a higher priority (hereinafter, referred to as “higher priority task”) is executed first. During the execution of the higher priority task, a task having a lower priority (hereinafter, referred to as “lower priority task”) is placed into the wait state. Upon completion of the higher priority task, the lower priority task starts. Consequently, if execution of a higher priority task is requested during execution of a lower priority task, the lower priority task is interrupted and placed into the wait state. Then, execution of the higher priority task starts.

JP patent application publication No. 2004-280297 discloses a conventional task management technique.

An “exclusive process” is a special process performed by a task. The exclusive process involves access to a resource that is shared among a plurality of tasks. Concurrent access by two or more tasks to the shared resource causes a problem. Thus, when starting an exclusive process, which requires exclusive use of a shared resource, the task requests the OS to prohibit access to the shared resource by any other task. Upon receipt of the request, the OS prohibits all the other tasks from starting an exclusive process, ignoring the priorities of the tasks. Upon completion of the exclusive process by the task, the completion is notified to the OS. Upon receipt of the notification, the OS permits the other tasks to start an exclusive process. Under such control by the OS, once a specific task starts an exclusive process, until the exclusive process completes and thus the shared resource is released, it is ensured that no other tasks are permitted to start an exclusive process. This holds even if the priorities of the other tasks are higher. One example of an exclusive process is a series of operations of reading, incrementing, and overwriting a variable commonly used by a plurality of tasks. Note that a segment of a program from the start to end of an exclusive process is called “critical section”.

The following describes the details of task management by way of example.

First of all, a reference is made to FIG. 5. In the example shown in FIG. 5, a program P includes three tasks T1-T3. The tasks T1, T2, and T3 are assigned a decreasing order of priorities P1, P2, and P3, respectively. In this example, the task T3 starts a normal process at time t0 and enters a critical section at time t1 (REQ→START). At time t2, the task T1 having a higher priority than the task T3 starts a normal process. As a result, the task T3 suspends execution of the critical section and goes into the pause state (PAUSE). At time t3, the task T1 completes the normal process and successively requests to start an exclusive process that requires access to the shared resource currently used by the task T3 (REQ). However, since the task T3 is already in the critical section and needs to be completed by priority, the task T1 is placed into the wait state (WAIT). At time t4, the task T2 having a higher priority than the task T3 starts a normal process. Thus, the task T3 is again placed into the pause state (PAUSE). At time t5, the task T3 is allowed to restart the exclusive process (RESTART). At time t6, the task T3 completes the exclusive process (END2), so that the task T1 having long been placed in the wait state finally enters the critical section (START).

As described above, there is an undesirable possibility in a series of task executions. That is, the task T1 having the highest priority among all the tasks needs to wait to enter its critical section for a relatively long period from time t3 to t6.

By closely reviewing the period from time t4 to t5, the following is noted. Because of the normal operation executed by the task T2 during the period, the task T3 suspends execution of the critical section. As a result, the task T1 has to wait an extra time period until the process by the lower priority task T2 completes.

That is to say, a conventional task management scheme has a problem that the task T2 having a lower priority indirectly blocks the task T1 having a higher priority for a period from time t4 to t5.

In order to address the above problem that a higher priority task has to wait for an extra time period because of a lower priority task, the following has been suggested. If a specific task has entered its critical section and then another task having a higher priority requests to enter its critical section, the priority of the specific task in the critical section is temporarily raised to the level equal to the priority of the other task. In this specification, a process of changing the priority to the level equal to that of another task is called “priority inheritance”.

A description of priority inheritance is disclosed in the following document:

“Priority Inheritance Protocols: An Approach to Real-Time Synchronization” written by Lui Sha, Ragunathan Rajkumar, and John P. Lehoczky (IEEE Transaction on Computers, Vol.39, No.9, pp.174-184, 2004)

With reference to FIG. 6, a task T3 enters a critical section at time t1. During the time the task T3 is still in the critical section, a task T1 having a higher priority issues a request at time t3 for entry into a critical section (REQ). Concurrently, the task T3 inherits the priority P1 of the task T1, so that the priority of the task T3 is raised to the level equal to the priority of the task T1. Thus, the task T3 is allowed to continue execution of the critical section and then exits the critical section at time t5 (END2). Upon exit from the critical section, the task T3 returns to its original priority. The time period starting upon the entry into and exit from a critical section by the task T3 is called a “priority inheritance period”. During the priority inheritance period, the task T2 requests to initiate a process at time t4. Originally, the task T2 has a higher priority than the task T3. Yet, since the task T3 temporarily inherits the priority P1 of the task T1, the task T3 is executed by priority over the task T2.

As described above, the conventional technique solves the problem noted above by the priority inheritance scheme. The priority inheritance scheme ensures that execution of the critical section by the task T3 is not interrupted by the task T2. As a consequence, it is ensured that the task T1 having a higher priority is not indirectly blocked by the task T2 having a lower priority.

According to the above conventional technique, the tasks T1-T3 are assigned their respective priories relative to one another. It should be noted, however, that there may be a case where no priority order is established between tasks. More specifically, for example, in the case of two application programs that independently operate, there is no correlation between a group of tasks belonging to one of the application program and a group of tasks belonging to the other. Thus, no priority order should be established between the two task groups.

FIG. 7 illustrates such an example.

With reference to FIG. 7, one program includes tasks TA1-TA2 (collectively referred to as a “task group A”) and another program includes a task TB1 (referred to as a “task group B”). In the task group A, the priority (PA1) of the task TA1 is higher than the priority (PA2) of the task TA2. In this example, each of the task TA2 and task TB1 starts a normal process at time t0. After both the tasks complete the respective normal processes, the task TA2 enters its critical section at time t1 (REQ→START). Then, at time t2, the task TA1 having a higher priority than the task TA2 starts a normal process. As a result, the task TA2 suspends execution of the critical section and goes into the pause state (PAUSE). At time t3, the task TB1 completes the normal process and sequentially requests to execute an exclusive process that requires access to the shared resource currently used by the task TA2 (REQ). Yet, being blocked by the task TA2 that is already in its critical section, the task TB1 is placed into the wait state (WAIT). Then, the task TA2 restarts the suspended exclusive process (RESTART) at time t4, and completes the exclusive process at time t5 (END1). Upon completion of the exclusive process by the task TA2, the task TB1 having been placed in the wait state finally enters its critical section (START).

As described above, there is possibility in a series of task executions that the task TB1 is blocked by the task TA1 although the task TA1 has no priority over the task TB1. As a result, the task TB1 needs to wait to enter its critical section for a relatively long period from time t3 to t5.

By closely reviewing the period from time t3 to t4, the following is noted. Because the task TA1 starts a normal operation, the task TA2 is caused to suspend execution of its critical section. As a consequence, the task TA1 ends up blocking the task TB1 although no priorities are assigned relative to each other.

If the above conventional technique is applied to the example shown in FIG. 7, priority inheritance will take place between the tasks TA1 and task TB1 that are assigned no priorities relative to each other. It should be noted, however, since there is no correlation between the task groups A and B, the task TB1 should not inherit the priority of the task TA1. In light of this, it is concluded that the conventional technique is not applicable to the above example shown in FIG. 7.

The present invention is made in view of the above problems, and aims to provide a task execution controller, task execution control method, and program for managing a plurality of task groups not having priorities relative to each other. With the task execution controller, task execution control method, and program, it is prevented that a task is blocked by another task and placed in the wait state for a relatively long time.

### SUMMARY OF THE INVENTION

In order to achieve the above aims, the present invention provides a task execution controller for managing a plurality of task groups each composed of a plurality of tasks to sequentially select and execute tasks in an order of priorities assigned thereto within the respective task groups. The task execution controller includes a task group judging unit and a priority control unit. The task group judging unit is operable to judge whether a first task and a second task belong to a same group, upon a request from the second task to access a resource that is shared among the plurality of task groups and is currently accessed by the first task. If the first and second tasks are judged to belong to the same group, the priority control unit is operable to compare priorities of the first and second tasks and cause the first task to inherit the priority of the second task if the priority of the second task is higher. If the first and second tasks are judged to belong to different groups, the priority control unit is operable to raise a priority of the first task by a predetermined value.

With the above structure, if the task already in its critical section (task T1) and the task requesting to newly enter its critical section (task T2) belong to the same task group, the task execution controller according to the present invention employs the priority inheritance scheme. More specifically, the priority of the task T1 is raised to the minimum level necessary to avoid that the Task T2 is placed into the wait state for a long time. In addition, if the tasks T1 and T2 be long to different task groups, the task execution controller according to the present invention raises the priority of the task T1, without employing the priority inheritance scheme. As a result, it is avoided that the execution of its critical section is easily blocked by other tasks. As a consequence, it is avoided that a task is placed in the wait state for a relatively long time because of other tasks having no relative priorities.

The predetermined value may be set so as to raise the priority of the first task to a highest level in the task group to which the first task belongs.

With this structure, the priority of the task T1 is raised to the highest level in the task group to which the task T1 belongs. Thus, it is ensured that the critical section of the task TA is not interrupted because of another task.

The predetermined value may be equal to or greater than a difference between highest and lowest priorities in the task group to which the first task belongs.

With this structure, the following advantage is achieved. Suppose, for example, two or more tasks enter their critical sections and their priorities are raised. In this case, since the respective priorities are raised uniformly by the predetermined value, the same priority order is maintained among the tasks before and after the priority change.

The priority control unit may be further operable to return the changed priority of the first task to the original level when the first task completes the access to the shared resource.

With this structure, as soon as the time the task T2 exits from the critical section, the priority of the task T2 returns to its original level. Thus, the task management is performed based on the originally assigned priority levels.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram schematically showing major components of an information processing system 100 into which a task execution device 200 according to the present invention is embedded;

FIG. 2 is a diagram schematically showing the relation between the task execution controller 200 and tasks;

FIG. 3 is a flowchart of task management performed by the task execution controller 200;

FIG. 4 is a time chart showing execution of tasks, under control by the task execution control device 200;

FIG. 5 is a time chart showing execution of tasks, under conventional task execution control performed in accordance with the priority order;

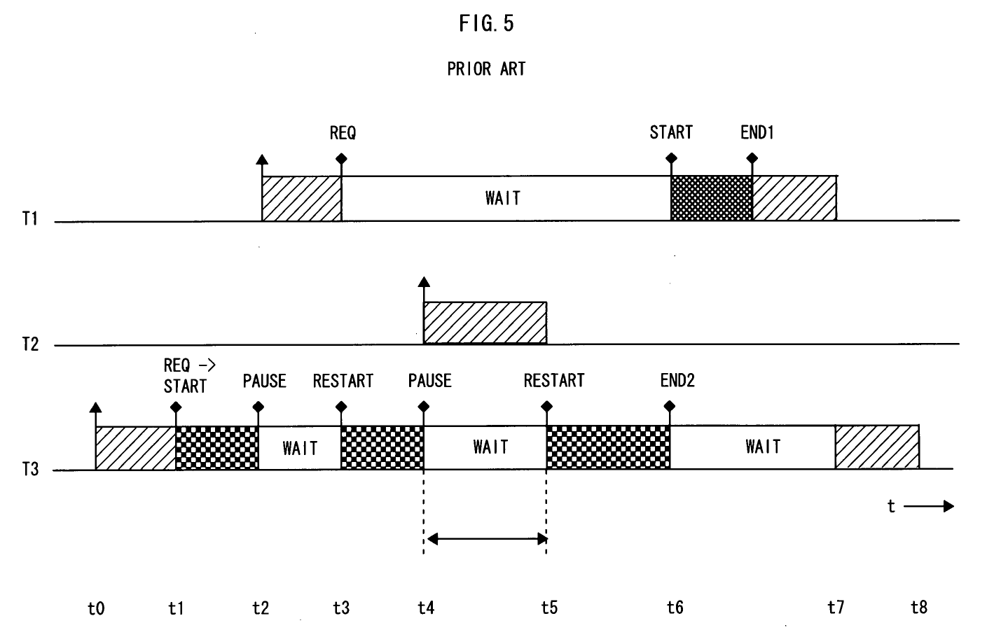

FIG. 6 is a time chart showing execution of tasks, under conventional task execution control performed by employing a priority inheritance scheme; and

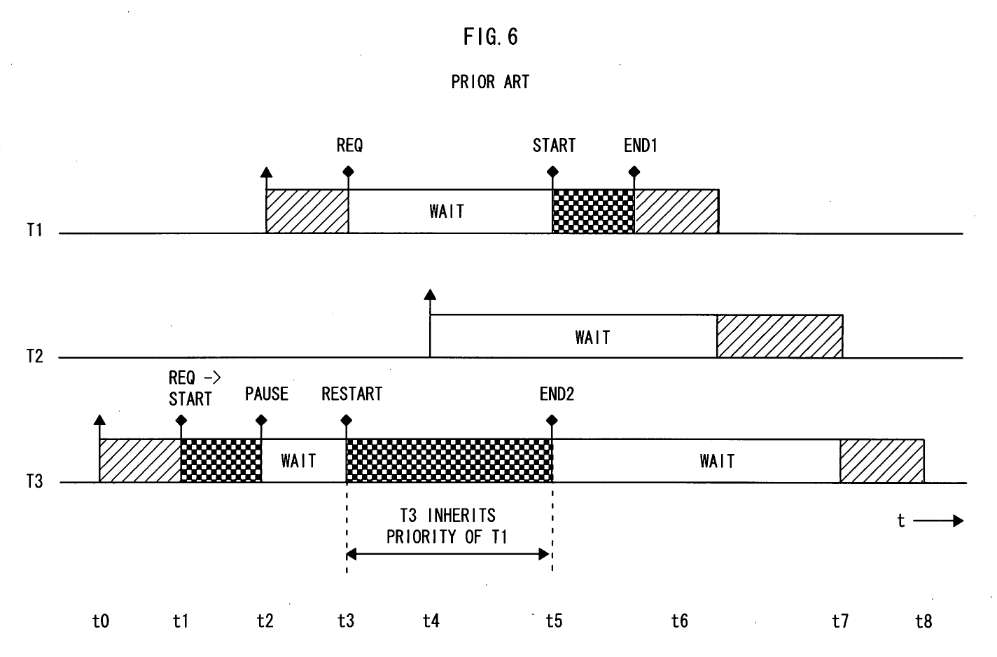

FIG. 7 is a time chart showing execution of tasks belonging to different task groups, under conventional task execution control.

### DESCRIPTION OF THE PREFERRED EMBODIMENT

Hereinafter, a description is given of an embodiment of the present invention, with reference to the accompanying drawings.

<1. Hardware Structure>

The task execution controller according to the present invention is functionality implemented as software for task management, which is one function of an OS. The task execution controller is embedded in an information processing system, such as a PC (Personal Computer), for use.

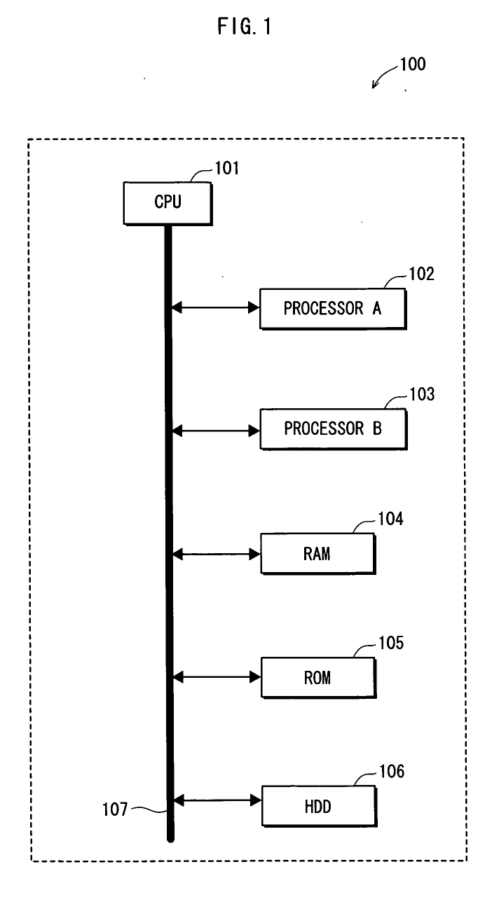

FIG. 1 is a block diagram schematically showing major components of an information processing system 100 into which a task execution device 200 according to the present invention is embedded.

With reference to FIG. 1, the information processing system 100 includes a CPU 101, a processor A102, a processor B103, RAM (Random Access Memory) 104, ROM (Read Only Memory) 105, an HDD (Hard Disk Drive) 106, and a bus 107.

The CPU 101 is the main processor that controls overall operations of the information processing system 100 and executes various programs under control by an OS.

The processor A102 is a sub-processor that executes specific processing in the information processing system 100. For example, the processor A102 executes an image processing program.

The processor B103 is a sub-processor that executes specific processing in the information processing system 100. For example, the processor B103 executes an audio processing program. Note that the processors A102 and B103 are both sub-processors but execute programs independently.

The RAM 104 is writable memory and used to load programs to be executed by the CPU 101 and the processors A102 and B103. The RAM 104 is also used to temporarily store working data of a program being executed. Examples of such programs include a BIOS (Basic Input/Output System), an OS and an application program.

The ROM 105 is read-only memory and used to permanently store programs and data. Examples of programs to be permanently stored include a BIOS.

The HDD 106 is a non-volatile storage device having a magnetic disc and used to store programs and data. Examples of such programs include an OS and application programs.

The bus 107 is a signal transmission line interconnecting the components described above.

Note that the information processing system 100 generally includes many other components, such as input and output devices. Yet, a description of such other components is omitted. This is because these components are not particularly important for the purpose of showing the task execution controller according to the present invention.

This concludes the description of the information processing system 100 into which the task execution controller is embedded.

<2. Task Execution Controller 200>

The following describes the task execution controller according to the present invention and also describes tasks managed by the task execution controller.

The task execution controller 200 is provided as functionality of an OS stored in the HDD 106 that is included in the information processing system 100.

The task execution controller 200 manages programs to be executed by the CPU 101 and the processor A102 and B103 in units called “tasks”. In addition, the task execution controller 200 manages a plurality of task groups each composed of a plurality of tasks. Upon execution of a program, one or more tasks are generated. In some cases, a plurality of tasks are sequentially generated and executed.

In addition, when executing a plurality of tasks that belong to the same group, the task execution controller 200 sequentially selects and executes the plurality of tasks in the decreasing order of priorities.

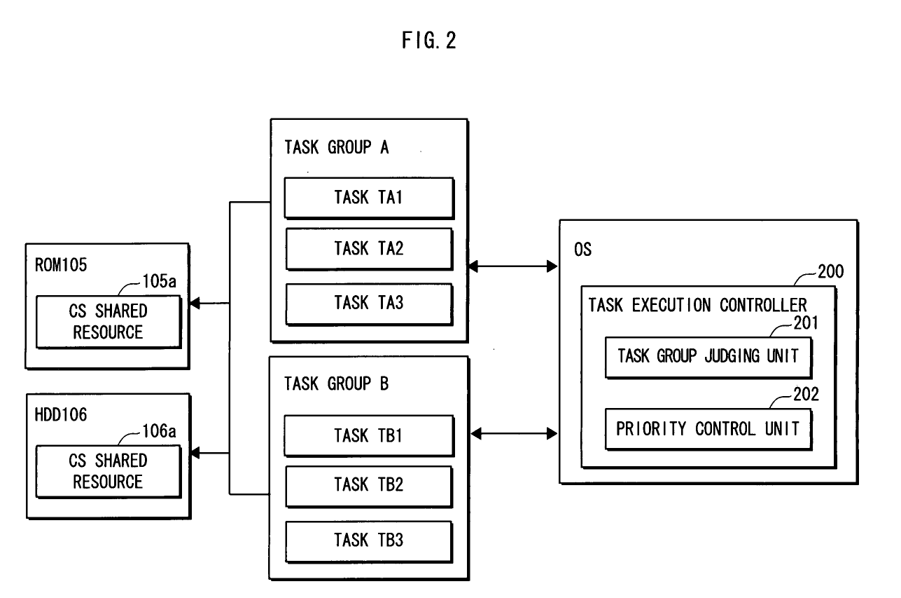

FIG. 2 is a diagram schematically showing the relation between the software-implemented task execution controller 200 and the tasks. The tasks shown in FIG. 2 are generated upon execution of different programs by the processors A102 and B103.

<2-1. Tasks and Task Groups>

With reference to FIG. 2, a task group A is a set of tasks TA that are generated upon execution of a program by the processor A102, whereas a task group B is a set of tasks TB that are generated upon execution of another program by the processor B103. In practice, the tasks TA and TB in the respective task groups A and B are temporality stored into the RAM 104 during the program execution.

Here, a description of tasks TA and tasks TB are given.

The tasks TA belonging to the task group A are assigned priorities. In the example shown in FIG. 2, the tasks TA1, TA2, and TA3 are assigned the descending order of priorities PA1, PA2, and PA3, respectively.

Similarly, the tasks TB belonging to the task group B are assigned priorities. In the example shown in FIG. 2, the tasks TB1, task TB2, and task TB3 are assigned the descending order of priorities PB1, PB2, and PB3, respectively. Note, however, that no priority order is established between the task groups A and B. Thus, the tasks TA1-TA3 have no priorities relative to the tasks TB1-TB3 and vice versa.

As described above, the plurality of tasks are assigned priorities separately within the respective task group. When execution of two or more tasks belonging to the same task group is concurrently requested, the task execution controller 200 causes a task having a higher priority to be executed first. During execution of the higher priority task, the other tasks having lower priorities are placed in the wait state. Upon completion of the higher priority task, a task having a next highest priority among the remaining tasks is executed next. That it to say, if execution of a higher priority task is requested during execution of a lower priority task, the lower priority task is interrupted and placed into the wait state. Then, execution of the higher priority task starts.

In addition, since the tasks TA and TB share a resource, an exclusive operation requiring exclusive use of the shared resource is performed. During the exclusive process, access to the shared resource by any other tasks TA and TB causes a problem. The segment of a program corresponding to the exclusive process is called a “critical section”. Upon entry into a critical section to start an exclusive process, the task requests the OS to prohibit any other access to the shared resource by any other tasks. Upon receipt of the prohibition request, the OS prohibits all the other tasks TA and TB, regardless of their priorities, from accessing the shared resource that is currently used by the task issued the prohibition request. Upon completion of the exclusive process and the task exits the critical section, the OS is informed of the situation. The OS then permits the other tasks to start an exclusive process. Under control by the OS as described above, once a specific task starts an exclusive process, any other task, even a higher priority task, is not allowed to start an exclusive process until the specific task completes the exclusive process and release the shared resource.

One example of an exclusive process is a series of operations of reading, incrementing, and overwriting a variable commonly used by a plurality of tasks.

Note that to “share” a resource used herein means that tasks TA and TB commonly but not concurrently use the same resource. That is to say, only a single task at a time is allowed to access the shared resource.

With reference to FIG. 2, in the information processing system 100, each of the ROM 105 and HDD 106 includes a “CS shared resource”. Each CS shared resource is shared by the tasks TA1-TA3 and the tasks TB1-TB3 and thus requires to be processed exclusively by a single task at a time.

<2-2. Structure of Task Execution Controller 200>

Now, a description is given of the task management performed by the task execution controller 200.

The task execution controller 200 controls task execution in the case of contention of access to the CS shared resource 105a in the ROM 105 or the CS shared resource 106a. More specifically, the task execution control is performed in the case where two or more tasks of the tasks TA belonging to the task group A and the tasks TB belonging to the task group B concurrently request to access any of the CS shared resources to perform an exclusive process.

With reference to FIG. 2, the task execution controller 200 includes a task group judging unit 201 and a priority control unit 202.

In the case of contention between two tasks both requesting to execute an exclusive process, the task group judging unit 201 judges whether the two tasks belong to the same task group. To this end, the task group judging unit 201 compares application program IDs of the respective tasks.

The priority control unit 202 controls execution of the two tasks according to the result of judgment by the task group judging unit 201.

<2-3. Operations of Task Execution Controller 200>

The following describes in detail operations of the task execution control preformed by the task execution controller 200.

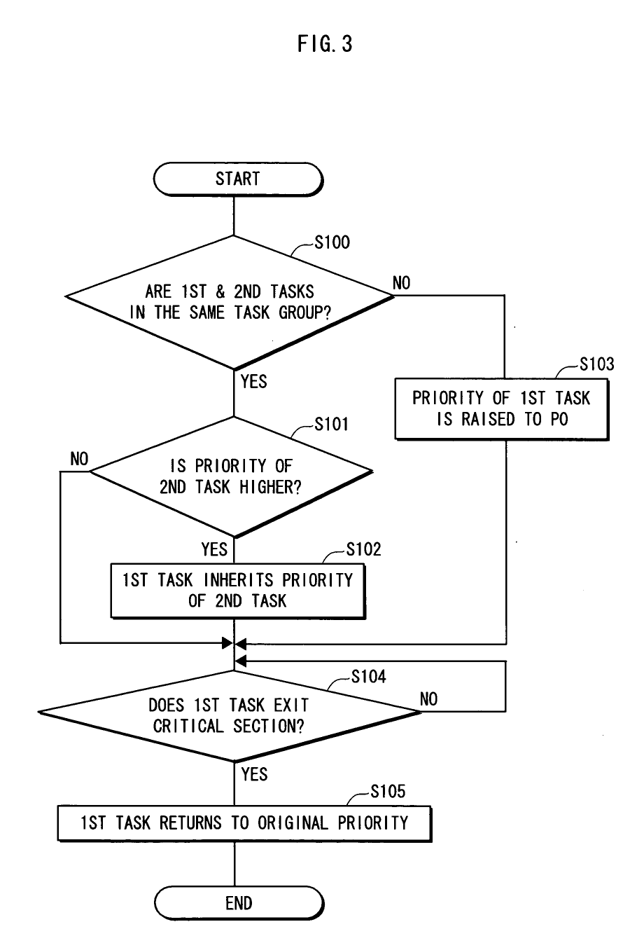

FIG. 3 is a flowchart of task management performed by the task execution controller 200.

With reference to FIG. 3, a first task of a plurality of tasks enters its critical section to execute an exclusive process. During the execution, another one of the plurality of tasks (second task) issues a request to enter its critical section. Upon receipt of the request, the task group judging unit 201 judges whether the first task and the second task belong to the same task group (Step S100).

If it is judged in Step S100 that the first and second tasks belong to the same task group (Step S100: YES), the priority control unit 202 judges whether the priority of the second task is higher than the priority of the first task (Step S101). If it is judged that the priority of the second task is higher (Step S101: YES), the priority control unit 202 so operates that the priority of the first task is stored into the RAM 104 and that the first task inherits the priority of the second task (Step S102). On the other hand, if it is judged that the first and second tasks have the same level of priorities or that the priority of the first task is higher (Step S101: NO), no priority inheritance takes place.

If it is judged in Step S100 that the first and second tasks belong to mutually different task groups (Step S100: NO), the priority control unit 202 so operates that the priority of the first task is stored into the RAM 104 and that the priority of the first task is raised to the highest level (P0) in the task group to which the first task belongs (Step S103).

Then, when the first task completes the exclusive process and exits the critical section, the OS is informed of the situation (Step S104: YES). Then, the priority control unit 202 sets the priority of the first task to the level stored in the RAM 104, so that the priority of the first task is returned to its original level (Step S105). Note that the priority control unit 202 is illustrated in FIG. 3 as repeatedly monitoring whether the task exits the critical section. Yet, this is merely for the convenience sake in the illustration. In practice, the priority control unit 202 judges that the task exits the critical section when the OS receives such a notification.

As described above, according to the task management by the task execution controller 200, if the first and second tasks belong to the same task group, the priority order is established between the two tasks. Thus, the priority inheritance is performed. On the other hand, if the first and second tasks belong to different task groups, no priority inheritance should be performed. Accordingly, the priority of the first task is increased to the highest level in the task group to which the first task belongs.

<2-4. Specific Examples>

The following describes in detail operations of the task execution control by the task execution controller 200 by way of specific examples.

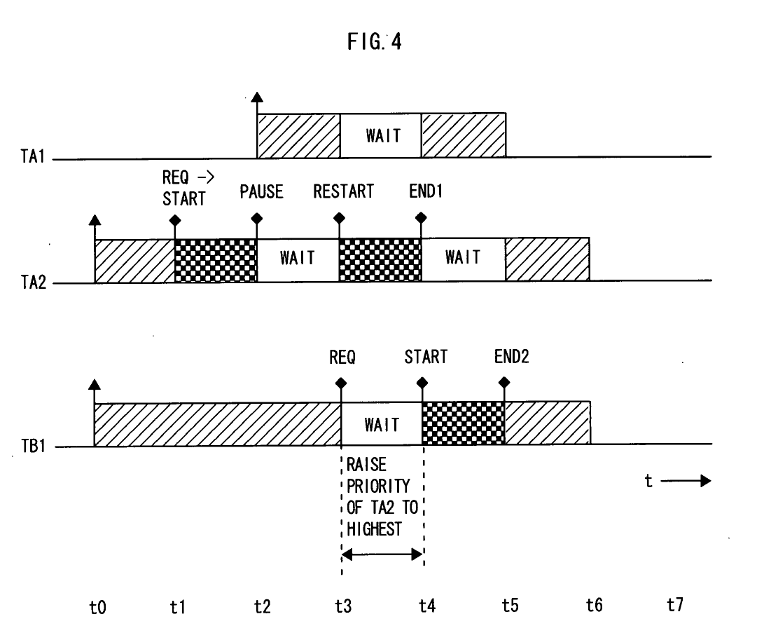

FIG. 4 is a time chart showing execution control of tasks performed by the information processing system 100. More specifically, tasks TA belonging to a task group A are of a program executed by the processor A102, whereas a task TB belonging to a task group B is of a program executed by the processor B103.

With reference to FIG. 4, the task TA2 and the task TB1 both start a normal process at time t0. After completion of the normal process, the task TA2 enters its critical section at time t1 (REQ→START). Then, at time t2, the task TA1 having a higher priority than the task TA2 starts a normal process. Thus, the task TA2 suspends the process execution of the critical section and goes into the pause state (PAUSE). At time t3, the task TB1 completes the normal process and requests to start an exclusive process requiring access to the shared resource currently used by the task TA2 (REQ). Upon receipt of the request REQ from the task TB1, the task group judging unit 201 judges whether the tasks TA2 and TB1 belong to the same task group (Step S100). Since the tasks TA2 and TB1 belong to mutually different task groups, the priority control unit 202 raises the priority of the task TA2 to P0, which is the highest priority level in the task group A (Step S103). As a result of the priority change, the task TA2 now has the priority P0, which is higher than the priority P1 of the task TA1. Thus, at time t3, the task TA1 suspends the normal process and goes into the pause state (PAUSE). Concurrently, the task TA2 restarts the exclusive process having been suspended and again enters its critical section (RESTART). When the task TA2 exits the critical section at time t4 (END1), the priority control unit 202 changes the priority level of the task TA2 back to its original priority P2 (Step S104). Then, the task TB1 enters its critical section at time t4 (START).

As described above, by changing the priority level of the task TA2 at time t3, it is prevented that the task TA2 indirectly delays the start of exclusive process by the task TB1.

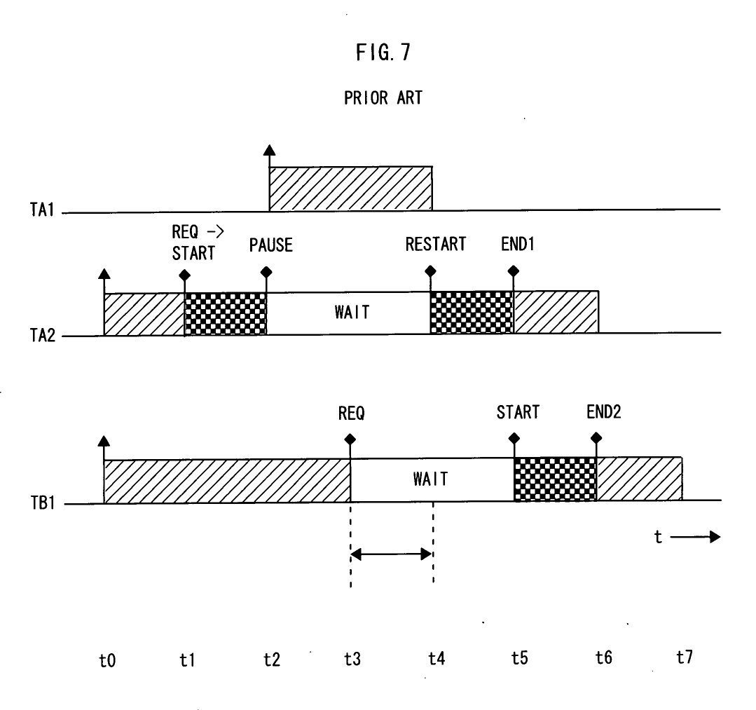

In the conventional example shown in FIG. 7, the task TB1 is placed in the pause state for the period from time t3 to t5. In contrast, in the example of the present embodiment shown in FIG. 4, the task TB1 is placed in the pause state for the period from time t3 to t4. That means the waiting time of the task TB1 is shorter by the period from time t4 to t5.

As has been described, the task execution controller 200 according to the present invention ensures the following. In the case where the first and second tasks belong to the same task group, the first task inherits the priority of the second task, so that the priority of the first task is raised to a minimum level necessary to avoid contention between exclusive processes. As a result, the waiting time of the second task is reduced. In the case where the first and second tasks belong to mutually different task groups, on the other hand, the priority of the first task is raised to the maximum level in the task group to which the first task belongs. Consequently, the waiting time of the second task resulting from contention between exclusive processes is reduced.

<3. Modification>

According to the embodiment described above, if it is judged that the first and second tasks belong to different task groups (Step S100: NO), the priority control unit 202 raises the priority of the first task to the priority (P0), which is the highest priority level in the task group to which the first task belongs (Step S103). Yet, this control by the priority control unit 202 may be modified as follows.

That is, if it is judged that first and second tasks belong to different task groups (Step S100: NO), the priority control unit 202 calculates a difference between the highest and lowest priority levels in the task group to which the first task belongs (task group A) and determines a value equal to or greater than the difference as a predetermined value. The priority control unit 202 then raises the priority of the first task by the predetermined value.

With this arrangement, if another task (referred to as the “third task”), in addition to the first task, belonging to the task group A requests an exclusive process requiring access to the shared resource, the priorities of the first and third tasks are raised equally by the predetermined value. Thus, the original priority order established between the first and third tasks is maintained even after the respective priorities are raised.

Suppose, for example, that the priority of the first task is P5 and the priority of the third task is P7. In addition, the highest and lowest priorities in the task group A are P1 and P10, respectively. In this case, the difference between P1 and P10 is “9”. Thus, the predetermined value is any arbitrary value equal to or greater than “9”. Suppose that the predetermined value is “9”, the priority control unit 202 raises the priority of the first task to P(−4), and raises the priority of the third task to P(−2). In view of the respective priorities of the two tasks, the difference between the priorities of the first and third tasks remains “2”. That is to say, the same priority order is maintained between the two tasks before and after the priority change.

<4. Supplemental Note>

As described above, the task execution controller according to the present invention has been described by way of the embodiment and modification. Yet, the present invention is not limited to such and further modifications including the following may be made.

(1) In the embodiment described above, each of the ROM 105 and HDD 106 includes a CS shared resource that is shared by the tasks and requires an exclusive process. Yet, the present invention is not limited to such, and a CS shared resource may be present in the RAM 104.

(2) The embodiment described above relates to a so-called multiprocessor hardware structure in which separate processors (processors A and B) independently perform different task groups having no relative priorities. Yet, the present invention is not limited to such.

For example, the present invention is applicable to a hardware structure in which a single processor performs separate task groups by time division multiplexing in different time slots.

(3) In the embodiment described above, the task execution controller 200 is implemented as one function of the OS stored on the HDD 106. Yet, the present invention is not limited to such and may be stored on the RAM 104 or ROM 105.

(4) The present invention may be embodied as a computer program to be executed by a computer system for realizing the method described in the above embodiment or as a digital signal representing the computer program. Still further, the present invention may be embodied as the computer program or the digital signal stored on a computer-readable recording medium. Examples of compute-readable recording media includes a flexible disk, hard disk, CD-ROM, MO, DVD, DVD-ROM, DVD-RAM, BD (Blu-ray Disc), and semiconductor memory. Still further, the present invention may be embodied as the computer program or digital signal per se stored on such a recording medium.

Still further, the present invention may be embodied as the computer program or digital signal that is transmitted via a telecommunication network, wireless or wired communication network, a network typified by the Internet, or data broadcasting.

Still further, the program or digital signal mentioned above may be transferred in form of a recording medium mentioned above, or via a network mentioned above, so that the program or digital signal may be executed by another independent computer system.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A task execution controller for managing a plurality of task groups each composed of a plurality of tasks to sequentially select and execute tasks in an order of priorities assigned thereto within the respective task groups, the task execution controller comprising:
a task group judging unit operable to judge whether a first task and a second task belong to a same group, upon a request from the second task to access a resource that is shared among the plurality of task groups and is currently accessed by the first task; and
a priority control unit operable to
(a) compare priorities of the first and second tasks if the first and second tasks are judged to belong to the same group, and cause the first task to inherit the priority of the second task if the priority of the second task is higher, and
(b) raise a priority of the first task by a predetermined value, if the first and second tasks are judged to belong to different groups.

2. The task execution controller of claim 1,
wherein the predetermined value is set so as to raise the priority of the first task to a highest level in the task group to which the first task belongs.

3. The task execution control device of claim 1,
wherein the predetermined value is equal to or greater than a difference between highest and lowest priorities in the task group to which the first task belongs.

4. The task execution controller of claim 1,
wherein the priority control unit is further operable to return the changed priority of the first task to the original level when the first task completes the access to the shared resource.

5. A task execution control method for managing a plurality of task groups each composed of a plurality of tasks to sequentially select and execute tasks in an order of priorities assigned thereto within the respective task groups, the task execution control method comprising:
a task group judging step of judging whether a first task and a second task belong to a same group, upon a request from the second task to access a resource that is shared among the plurality of task groups and is currently accessed by the first task; and
a priority control step of
(a) comparing priorities of the first and second tasks if the first and second tasks are judged to belong to the same group, and causing the first task to inherit the priority of the second task if the priority of the second task is higher, and
(b) raising a priority of the first task by a predetermined value, if the first and second tasks are judged to belong to different groups.

6. A program for causing a computer to perform a task execution control method for managing a plurality of task groups each composed of a plurality of tasks to sequentially select and execute tasks in an order of priorities assigned thereto within the respective task groups, the program comprising code operable to cause the computer to perform:
a task group judging step of judging whether a first task and a second task belong to a same group, upon a request from the second task to access a resource that is shared among the plurality of task groups and is currently accessed by the first task; and
a priority control step of
(a) comparing priorities of the first and second tasks if the first and second tasks are judged to belong to the same group, and causing the first task to inherit the priority of the second task if the priority of the second task is higher, and
(b) raising a priority of the first task by a predetermined value, if the first and second tasks are judged to belong to different groups.
